(19) United States
(12) Patent Application Publication
(10) Pub. No.: US 2018/0314886 A1
(43) Pub. Date: Nov. 1, 2018

(54) SYSTEM AND METHOD FOR AUTOMATED ANALYTIC CHARACTERIZATION OF SCENE IMAGE DATA

(71) Applicant: Pixel Velocity, Inc., Ann Arbor, MI (US)

(72) Inventor: David McCubbrey, Ann Arbor, MI (US)

(21) Appl. No.: 15/768,167

(22) PCT Filed: Oct. 11, 2016
(86) PCT No.: PCT/US16/56359

§ 371 Date: Apr. 13, 2018

Related U.S. Application Data
(60) Provisional application No. 62/242,055, filed on Oct. 15, 2015.

(51) Int. Cl. G06K 9/00; G01J 3/50; G06T 7/20; G06K 9/46

(52) U.S. Cl. CPC G06K 9/00624; G01J 3/50; G06T 13/80; G06K 9/46; G06T 7/20

(57) ABSTRACT

A system and method for automated analytic characterization of scene image data includes at least one image sensor, a processor, and a communication device in communication with the processor. The at least one image sensor is configured to capture image data of a field of view. The image data includes a plurality of image frames, the processor is configured to receive the image data from the at least one image sensor; detect object, region, and sequence information in each image frame, construct metadata of the image data based on a detected object, region, and sequence information in each image frame, and transmit to the central served the metadata.

### CROSS REFERENCE TO RELATED APPLICATION

This application claims priority to U.S. Provisional Application No. 62/242,055 filed on Oct. 15, 2015 all of which are herein incorporated by reference in their entirety.

### BACKGROUND

### 1. Field of the Invention

The present invention generally relates to systems and methods of interpreting scene image data.

### 2. Description of Related Art

Current systems and method for interpreting scene image data rely upon conventional video and image data compression methods, or else no compression at all, to communicate digital image sequences, including video data streams, to remote viewers. Such conventional compression cannot maintain, at one time, accurate scene object, region, and sequence descriptions together with low-cost communications.

Furthermore, prior art solutions depend upon essential scene object and region information to be extracted at the central viewing site for a multiplicity of simultaneous deployed remote imaging sensors. This imposes a time-consuming and costly workload upon the central viewing site and degrades the responsiveness of that site to diverse events that may require immediate action or other response.

### SUMMARY

A system and method for automated analytic characterization of scene image data includes at least one image sensor, a processor, and a communication device in communication with the processor. The at least one image sensor is configured to capture image data of a field of view. The image data includes a plurality of image frames. The processor is configured to receive the image data from the at least one image sensor; detect object, region, and sequence information in each image frame, construct metadata describing the image content based on a detected object, region, and sequence information in each image frame, and transmit to the central server the metadata. The metadata may be used to provide situational awareness to an observer at the central server location by animating icons on a map to provide a symbolic view of events at a remote location. Furthermore, the metadata itself is sufficient to generate automatic alerts to an observer, freeing them from any requirement to watch video at all, except perhaps to confirm an alert.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a block diagram of a device for automated analytic characterization of scene image data;

FIG. 2 illustrates a block diagram of a system having two devices for automated analytic characterization of scene image data; and

FIG. 3 illustrates a method for automated analytic characterization of scene image data.

### DETAILED DESCRIPTION

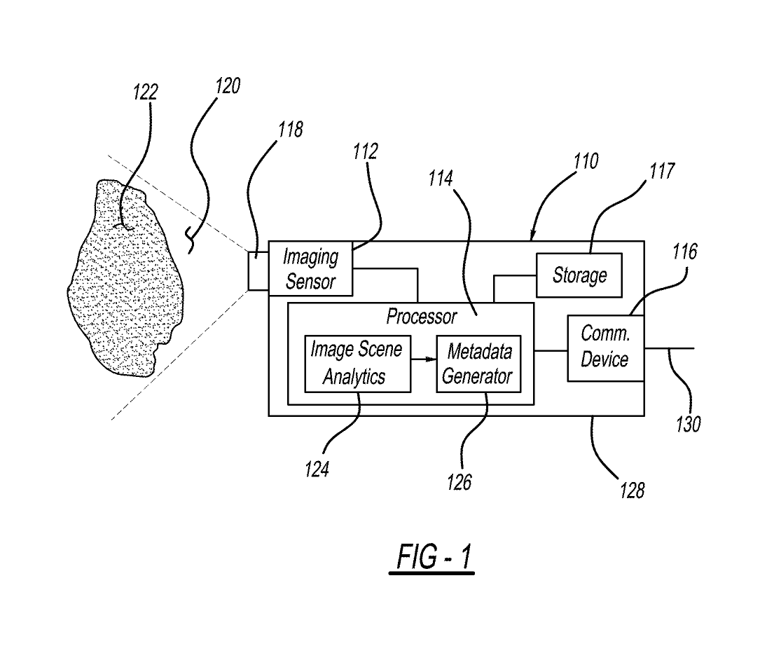

Referring to FIG. 1, a device 110 for automated analytic characterization of scene image data is shown. As its primary components, the device includes an imaging sensor 112, a processor 114, a communication device 116 and an image storage unit 117. The image storage unit 117 may be any type of digital information storage medium, such as a hard disk drive, solid state flash drive, or random access memory.

The imaging sensor 112 and the communication device 116 are in communication with the processor 114. The imaging sensor 112 and/or communication device 116 may be placed in communication with the processor 114 by any known method including a physical connection or a wireless connection.

The imaging sensor may be any type of imaging sensor capable of capturing image frames of an object 122 across a field of view 120. To that extent, the imaging sensor 112 may be any one of a number of different types. For example, the imaging sensor may be a semiconductor charge coupled device, active pixel sensor in complementary metal oxide semiconductor, or a thermal imaging sensor. Of course, it should be understood that any one of a number of different sensors or different types of sensors could be utilized so long as they are able to capture image data. It should also be understood that the imaging sensor 112 may contain more than one single sensor and may be an array of sensors working in concert to capture image data across the field of view 120.

Coupled to the imaging sensor 112 may be optics 118. The optics 118 may be one or more lenses capable of focusing and/or filtering visual data received within the field of view 120.

The communication device 116 allows the device 110 to communicate with external devices. This communication with external devices may occur via a cable 130. However, it should be understood that the communication device may communicate with external devices through other means, such as wireless technology. As such, the communication device 116 can be any one of a number of different devices enabling electronic communication with the processor 114. For example, the communication device may be an Ethernet related communication device allowing the processor 114 to communicate to external devices via Ethernet. Of course, other communications standard protocols could be used such as USB or IEEE1394.

As to the processor 114, the processor may be a single standalone processor or may be a collection of different processors performing various tasks described in the specification. Here, the processor 114 contains instructions for performing image scene analytics 124 and generating metadata based on the image scene analytics as shown by the metadata generator 126.

Image scene analytic processing includes of steps that isolate moving objects of interest (foreground regions) from objects that are always part of the scene (background regions). The techniques (e.g. frame differencing) for achieving this are well-known to those versed in the art.

The metadata generator 126 further analyzes each foreground region of the image and produces a small set of metadata that describes various attributes of the foreground region. For instance, metadata about the region's overall color, its position in the image, the classification of the region's type (person, vehicle, animal, etc) based on its shape are readily generated by analysis of the foreground region along with the corresponding region in the original image frame. The precise time that the image frame was generated is a further useful piece of metadata. Furthermore, using prior metadata and knowledge of the camera's physical position in the world and information about the sensor focal plane and camera lens, the metadata attributes of the moving region's ground position, physical width, physical height, and velocity can also be calculated using well-known techniques.

Generally, the processor 114 is configured to receive image data in the field of view 120 from the image sensor 112. From there, the processor can detect object information of the object 122, regional information, and sequence information in each image frame captured. These steps may be accomplished through a variety of image processing techniques, such as frame differencing, foreground/background modeling, etc.

The processor 114 is also configured to compress each image frame and store it, along with the precise time it was acquired, on storage medium 200 for later optional transmission to a central server.

The processor 114 is also configured to construct metadata about the image based on the detected object 122, region, and prior metadata information about each image frame. From there, this information can be transmitted by the communication device 116 to an external device such as a central server. Transmission is accomplished generally using typical network information streaming techniques such as network sockets.

Importantly, the amount of metadata transmitted to the central server from the communication device 116 is substantially less than the amount of image data captured by the image sensor 112.

By computing and transmitting only metadata using device 110 and processor 114, a central server connected to the communication device 116 will not need to perform any of the processing of the data captured by the imaging sensor 112, and furthermore will not need to receive the image data at all. This results in a significant reduction required for communication bandwidth and reduces the work load on a remote or central server. Most importantly, it can reduce the cost of the remote connection because connection cost is principally determined by bandwidth capacity.

A housing 128 may encompass and surround the processor 114, the communication device 116, and the imaging sensor 112. The housing 128 may have a slight opening so as to allow the lens 118 to protrude therefrom, however, the lens could be incorporated within the interior of the housing 128. Additionally, the housing 128 may have further openings for ports such as those ports capable of communicating with the communication device 116.

The processor 114 can also be configured to transmit a portion of the archived data stored on 200 comprising the image frames to the central server. This can be initiated by a command from the central server or can be automatically programmed to do so. By so doing, some image data can be transmitted to a central server, but by only transmitting a subset, less average communication bandwidth is required. For instance, a user could request to see only 10 seconds of video surrounding the time of an automatically generated alert, in order to confirm the nature of the activity that generated the alert. This information could be transmitted at a speed dictated by the available bandwidth, thus taking (for instance) 1 minute to transmit 10 seconds of video. Once the video clip is completely received at the central server it could be viewed at any suitable speed.

The processor 114 may also be configured to detect at least one object 122 in the image data and generate metadata related to at least one of the shape of the object, the size of the object, hoses of the object, object actions, objects proximities, object speed profile over time, and paths taken by the object in the three dimensional volume of space observed by the sensor.

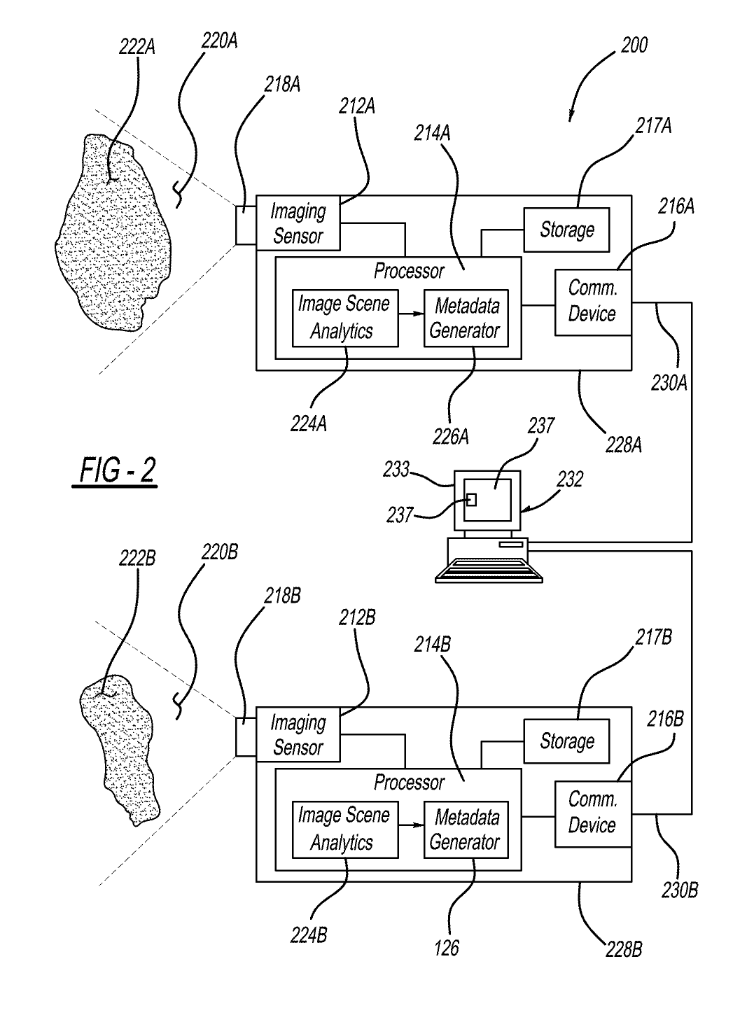

Referring to FIG. 2, a system 200 for automated analytic characterization of scene image data is shown. Here, the system includes two devices 210A and 210B. The devices 210A and 210B are similar to those described in FIG. 1, when describing device 110. As such, like reference numerals have been utilized to indicate like components and no further description will be provided. Here, the device 210 is capturing image data of a field of view 220A containing an object 222A.

The device 210B is capturing image data from a field of view 220B of an object 222B. As stated before, the processors 214A and 214B are configured to receive image data from the imaging sensors 212A and 212B, detect object region and sequence information in each image frame, construct metadata of the image data based on a detected object, region, and sequence information in each frame. Finally, the metadata generated is transmitted to a central server 232 by the cables 230A and 230B. The central server 232 can coordinate the image data received and metadata received from devices 210A and 210B. As stated before, because of band width limitations, the devices 210A and 210B are only providing a subset of the data processed by the processors 214A and 214B. However, the data provided to the central server 232 is such that the most valuable components of the data are provided to the central server 232, while less valuable components are not provided.

The metadata may be used to provide situational awareness to an observer at the central server 232 by animating icons 237 on a map 235 shown on a display 233 of the central server 232 to provide a symbolic view of events at a remote location. Furthermore, the metadata itself is sufficient to generate automatic alerts to an observer, freeing them from any requirement to watch video at all, except perhaps to confirm an alert.

By moving the processing of the imaging data captured by the image sensors 212A and 212B to the processors 214A and 214B, respectively, lower band width requirements between the devices 210A and 210B and the central server 232 can be realized, as the data to be processed is performed by the devices capturing the image data, and not a central server 232.

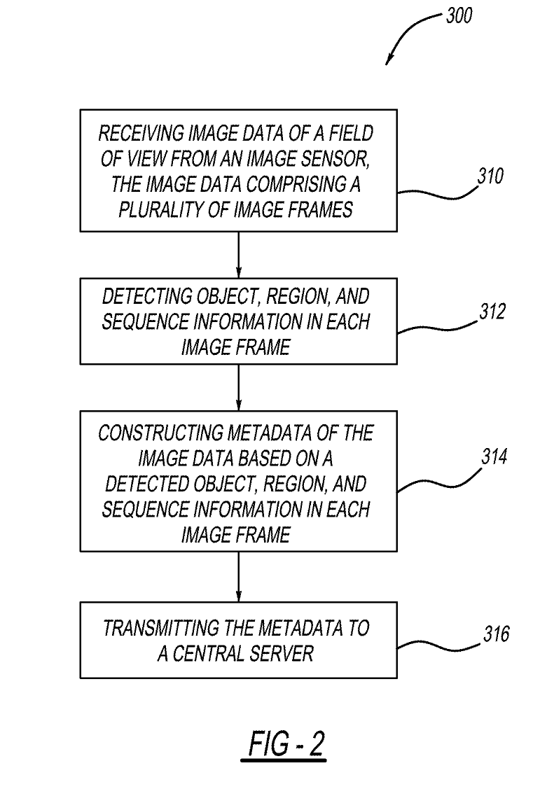

Referring to FIG. 3, a method 300 for interpreting scene image data is shown. In step 310, the method begins of a field of view from an image sensor. The image data may include a plurality of image frames. In step 312, the method detects object, region, and sequence information in each image frame. This may be accomplished by image scene analytic processing that includes steps that isolate moving objects of interest (foreground regions) from objects that are always part of the scene (background regions). The techniques (e.g. frame differencing) for achieving this are well-known to those versed in the art.

In step 314, the method constructs metadata of the image data based on detected object, region, and sequence information in each frame. Finally, in step 316, the metadata is transmitted to a central server. Metadata may be constructed by further analyzes each foreground region of the image and produces a small set of metadata that describes various attributes of the foreground region. For instance, metadata about the region's overall color, its position in the image, the classification of the region's type (person, vehicle, animal, etc.) based on its shape are readily generated by analysis of the foreground region along with the corresponding region in the original image frame. The precise time that the image frame was generated is a further useful piece of metadata. Furthermore, using prior metadata and knowledge of the camera's physical position in the world and information about the sensor focal plane and camera lens, the metadata attributes of the moving region's ground position, physical width, physical height, and velocity.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A device for automated analytic characterization of scene image data, the device comprising:
at least one image sensor for capturing image data of a field of view, the image data comprising a plurality of image frames;
a processor in communication with the at least one image sensor;
a communication device in communication with the processor, the communication device being configured to transmit information between processor and a central server;
wherein the processor is configured to receive the image data from the at least one image sensor; detect object, region, and sequence information in each image frame, construct metadata of the image data based on a detected object, region, and sequence information in each image frame, and transmit to the central server the metadata.

2. The device of claim 1, wherein the size of the metadata based on the image data and transferred to the central server is less than the image data captured by the at least one image sensor.

3. The device of claim 1, wherein the processor is further configured to transmit a portion of data comprising the image frames to the central server.

4. The device of claim 3, wherein the processor is further configured to transmit a portion of data comprising the image frames to the central server when receiving a command from the central server.

5. The device of claim 1, wherein the processor is configured to detect at least one object in the image data and generate metadata related to at least one of the following: camera ID, object classification (type), object shape, object sizes, object color, object poses, object actions, object proximities, object speed profile over time, and paths taken by the object in the 3-dimensional sensor-observed scene volume of space.

6. The device of claim 1, wherein the receiver of the metadata obtains sufficient information to draw conclusions about the remote situation without need for the actual image information itself.

7. The device of claim 1, wherein the processor is configured to construct metadata by isolating moving objects of interest in the field of view from objects that are always part of the field of view.

8. The device of claim 7, wherein the processor is configured to analyze each of the moving objects of interest in the field of view of the image and produce a set of metadata that describes at least one attribute of the moving objects of interest in the field of view.

9. The device of claim 8, wherein the at least one attribute includes at least one of the following: overall color, position in the image, classification by type of object based on shape, time that the image data was generated, physical position of the camera, information about the sensor focal plane and camera lens, and information about the object's ground position, physical width, physical height, or velocity.

10. The device of claim 9, wherein the processor is configured to generate an animation of an icon on a map that represents a position and type of detected object for providing situational awareness of the real-time behavior of the detected object.

11. A method for automated analytic characterization of scene image data, the method comprising:
receiving image data of a field of view from an image sensor, the image data comprising a plurality of image frames;
detecting object, region, and sequence information in each image frame;
constructing metadata of the image data based on a detected object, region, and sequence information in each image frame; and
transmitting the metadata to a central server.

12. The method of claim 11, wherein the size of the metadata based on the image data and transferred to the central server is less than the image data captured by the at least one image sensor.

13. The method of claim 11, further comprising the step of transmitting a portion of data comprising the image frames to the central server.

14. The method of claim 11, further comprising the step of transmitting a portion of data comprising the image frames to the central server when receiving a command from the central server.

15. The method of claim 11, further comprising the steps detecting of at least one object in the image data and generating metadata related to at least one of the following: object shape, object sizes, object color, object temperature, object poses, object actions, object proximities, object speed profile over time, and paths taken by the object in the 3-dimensional sensor-observed scene volume of space.

16. The method of claim 11, further comprising the step of constructing metadata by isolating moving objects of interest in the field of view from objects that are always part of the field of view.

17. The method of claim 16, further comprising the step of analyzing each of the moving objects of interest in the field of view of the image and producing a set of metadata that describes at least one attribute of the moving objects of interest in the field of view.

18. The method of claim 17, wherein the at least one attribute includes at least one of the following: overall color, position in the image, classification by type of object based on shape, time that the image data was generated, physical position of the camera, information about the sensor focal plane and camera lens, and information about the object's ground position, physical width, physical height, or velocity.

19. The device of claim 17, wherein the processor is configured to generate an animation of an icon on a map that represents a position and type of detected object for providing situational awareness of the real-time behavior of the detected object.
